(19) United States
(12) Patent Application Publication
(10) Pub. No.: US 2013/0139494 A1
(43) Pub. Date: Jun. 6, 2013

(54) METHOD FOR PROTECTING A COMPONENT OF A HYDRAULIC MACHINE AGAINST EROSION, COMPONENT MANUFACTURING USING THIS METHOD AND INSTALLATION COMPRISING SUCH COMPONENT

(71) Applicant: Serge Prigent, Le Sappey en Chartreuse (FR)

(72) Inventor: Serge Prigent, Le Sappey en Chartreuse (FR)

(73) Assignee: ALSTOM HYDRO FRANCE, Levallois Perret (FR)

(21) Appl. No.: 13/806,714

(22) PCT Filed: Jun. 21, 2011
(86) PCT No.: PCT/FR2011/051428

§ 371 Date: Feb. 14, 2013

(30) Foreign Application Priority Data
Jun. 24, 2010 (FR) 10 55051

(51) Int. Cl. B32B 37/22; F15B 21/00

(52) U.S. Cl. CPC B32B 37/22; F15B 21/00
USPC 60/325; 156/60; 156/278; 156/331.7; 156/331.6; 428/56

(57) ABSTRACT

A method for protecting a component of a hydraulic machine against erosion comprises steps involving preparing, in the flat state, several sheets of polymerised synthetic material, in applying a coat of adhesive to one side of each sheet 300 and in laying the sheets on the surface of the component that is to be covered with the layer of coating.

The invention relates to a method for manufacturing a component of a hydraulic machine of which at least one surface is covered with a protective layer of coating against erosion.

It is known that the surfaces of a component of a hydraulic machine intended to be wet by a forced flow passing through the machine must be protected from abrasion due to the solid particles present in the flow and, in general, against any form of erosion. Certain composite materials that are wear-resistant are intended to be affixed, for example, onto the blades of a hydraulic turbine. The erosion-resistant properties obtained thanks to these materials depend on how they are applied.

In order to apply such a material, it is known to sandblast the surface of a hydraulic component, for example a vane of a Francis wheel or a wicket gate, then to apply, with a spray gun, a primer, before applying the two components of the composite material, also with a spray gun, with a thickness greater than 1 mm. This constitutes a protective layer against erosion. The hardening time of such a composite material applied as such is of a magnitude of three weeks, which imposed that the component be immobilised during this duration. In the event of rehabilitating an existing energy conversion installation, this induces a significant stoppage of production. Furthermore, when the material comprising this protective layer is applied onto a warped/uneven surface, a substantial risk of runs exists, due to the relatively substantial thickness of the protective layer. At the very least, an orange-peel effect is observed.

In the case where the composite material were to be applied in several successive layers with relatively low thicknesses, for example of a magnitude of 400 micrometres (μm), the risks of runs would be reduced but the orange-peel aspect would remain. Furthermore, an application of the material in several layers would induce substantial degradation in the adherence of this material, as this adherence depends, among other things, on the application time between two successive layers of material. This would result in a risk of localised separation on a portion of the protective layer.

In the case of a relatively large component, such as a Francis wheel, this is carried out generally by sectors in order to apply the layer of protective material. During the sandblasting of a sector, the other sectors that are already covered with a protective layer of coating must be protected against the projections of sand. This is delicate to implement and requires time.

It is these disadvantages that the invention intends more particularly to overcome by proposing a new method for manufacturing a component of a hydraulic machine that is simpler to implement and that procures a better surface finish than known methods.

To this effect, the invention relates to a method of protection against the erosion of a component of a hydraulic machine of which at least one warped/uneven surface is covered with a protective layer of coating. This method comprises at least steps consisting in:
a) preparing in a flat state several sheets of polymerised synthetic material,
b) applying a coat of adhesive at least on one face of each sheet
c) laying the sheets on the warped/uneven surface of the component that is to be covered by constituting the layer of coating using sheets.

Thanks to the invention, the manufacturing of the protective layer of coating which is provided on one of the surfaces of a component of a hydraulic machine takes place in several successive steps, of which the step a) can take place several weeks before a direct action on the component. This prior step can be carried out in a dedicated workshop, in well-suited conditions, which makes it possible to obtain a surface finish that is entirely satisfactory of the external face of the layer of coating intended to interact with the forced flow passing through the hydraulic machine. A surface finish of the “mirror” type can be obtained, since the sheet of polymerised synthetic material can be prepared in a flat state, which prevents the risks of runs.

In terms of the invention, erosion covers abrasion and wear via cavitation and/or corrosion.

According to the advantageous but non-mandatory aspects of the invention, such a method can incorporate one or several of the following characteristics, taken in all technically permissible combinations:

During the step a), the sheet is carried out using a prepolymer base, in particular of the isocyanate type partially copolymerised with at least one polyol and/or one amine, and a hardener, in particular of the isocyanate type. The prepolymer base advantageously comprises at least one fluidifying agent or dispersant and/or a filler.

During the step a), the sheet is carried out with a thickness between 0.5 and 3 mm, more preferably between 1 and 2 mm.

The method comprises a step d), intermediary between the steps a) and b), of storing the sheet for finalisation of the polymerisation.

The step of storage takes place for several weeks, more preferably at least two months.

During the step a), the sheets are carried out with a thickness between 0.5 and 3 mm, more preferably between 1 and 2 mm.

The method comprises a step e), prior to the step c), of applying a coat of primer on the surface of the component that is to be covered with the protective layer or coating against erosion, while, during the step c), the sheet is laid by placing the coat of adhesive and the coat of primer into contact. Advantageously, during the step e), the primer is applied with a thickness between 20 and 100 μm, more preferably of a magnitude of 50 μm.

The method comprises a step f) after steps b) and e) wherein there is a waiting period for the adhesive and the primer to mature, before the laying of the sheets in step c).

During the step b), the adhesive is applied with a thickness between 20 and 150 μm, more preferably between 50 and 70 μm.

The adhesive applied during the step b) is of the polyurethane type or has a polyurethane base, of the polyester type or with a polyester base, or of the cyanoacrylate type or with a cyanoacrylate base.

Several sheets are prepared during the step a) and, during the step c), these sheets coated with adhesive are installed edge to edge on the surface of the component, and may be covered with the coat of primer.

The invention further relates to a component of a hydraulic machine of which some at least of the surfaces intended to be wet by a forced flow of water passing through the machine are covered with a protective layer of coating in sheet(s) prepared by polymerisation before they are laid on these surfaces, with this protective layer being more preferably affixed according to a method such as mentioned hereinabove.

In this case, the sheets can have a Shore hardness of 72, with an elastic elongation capability of about 400% as well as a tensile strength, according to standard NF T 46-002, of 28 megapascals and a resistance to tearing, according to standard NF T 46-007, of 35 newtons.

Finally, the invention relates to an installation for converting hydraulic energy into electrical or mechanical energy, or reciprocally, this installation comprising a hydraulic machine, a water supply line and at least one component of which at least one surface is swept by a flow of water passing through the installation. This installation is characterised in that the component is such as is mentioned hereinabove.

The invention shall be better understood and other advantages of the latter shall appear more clearly when reading the following description of an embodiment of an installation and of a method for manufacturing in accordance with its principle, provided solely by way of example and in reference to the annexed drawings wherein:

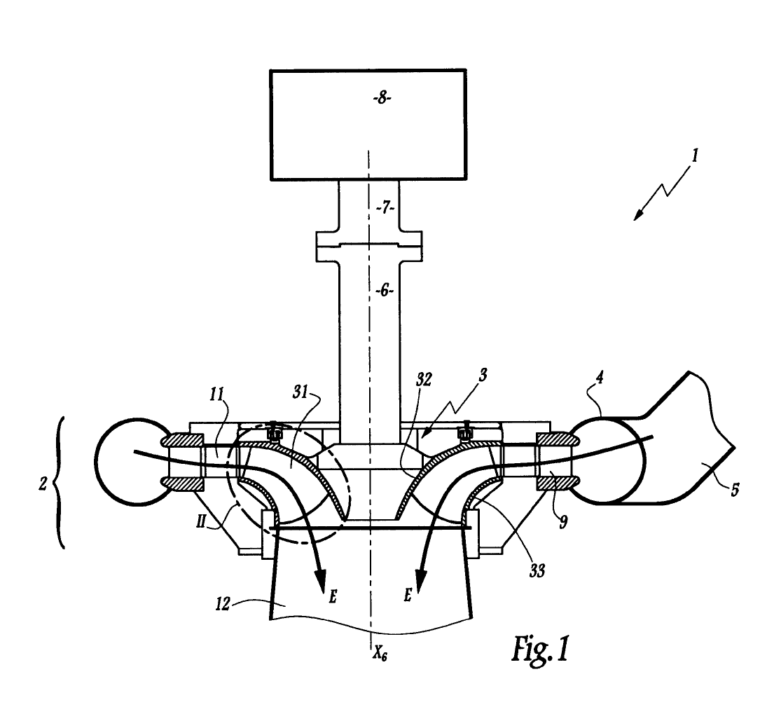

FIG. 1 is an axial cross-section in principle of an installation in accordance with the invention,

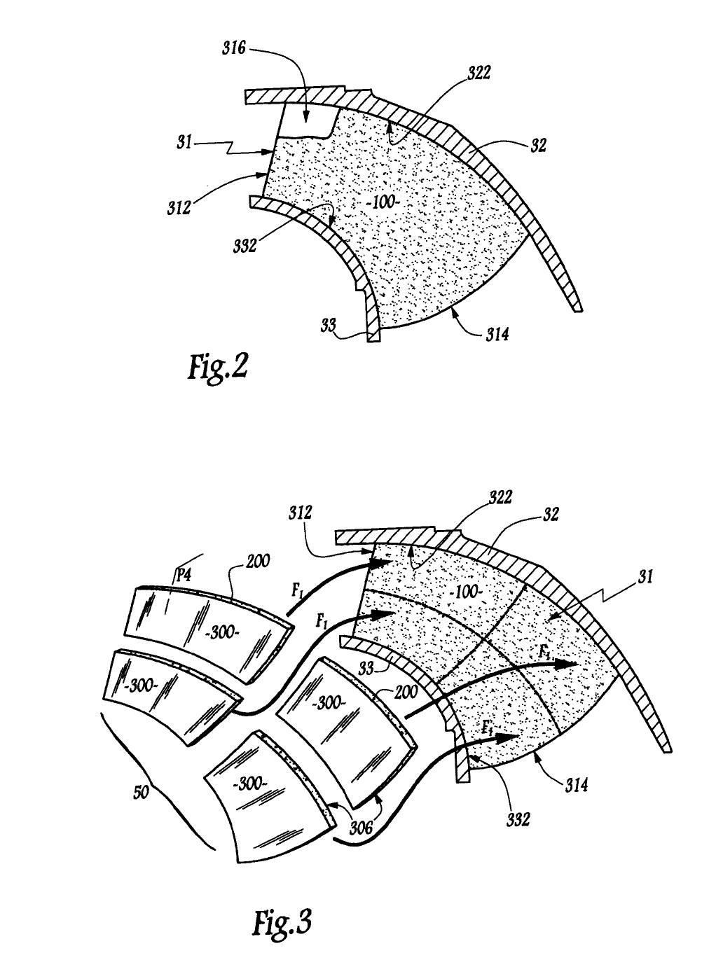

FIG. 2 is a view on a greater scale corresponding to the portion of the wheel of the installation of FIG. 1 forming the detail II in this figure, during a first step of a method of manufacture,

FIG. 3 is a view analogous to FIG. 2, although on a smaller scale, during a third step according to the method,

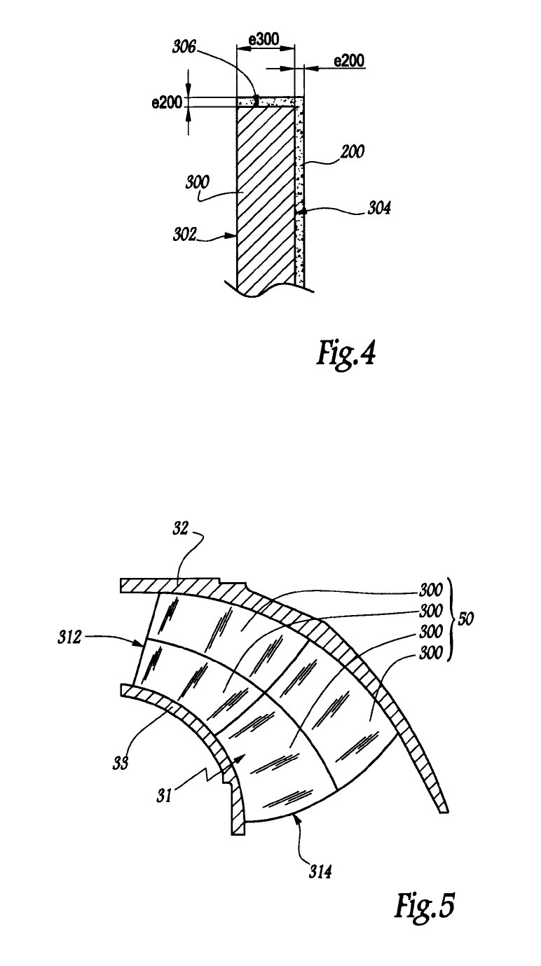

FIG. 4 is a partial cross-section and on a greater scale, according to the plane P4 in FIG. 3,

FIG. 5 is a view analogous to FIG. 4 during a step of the method after that of FIG. 3,

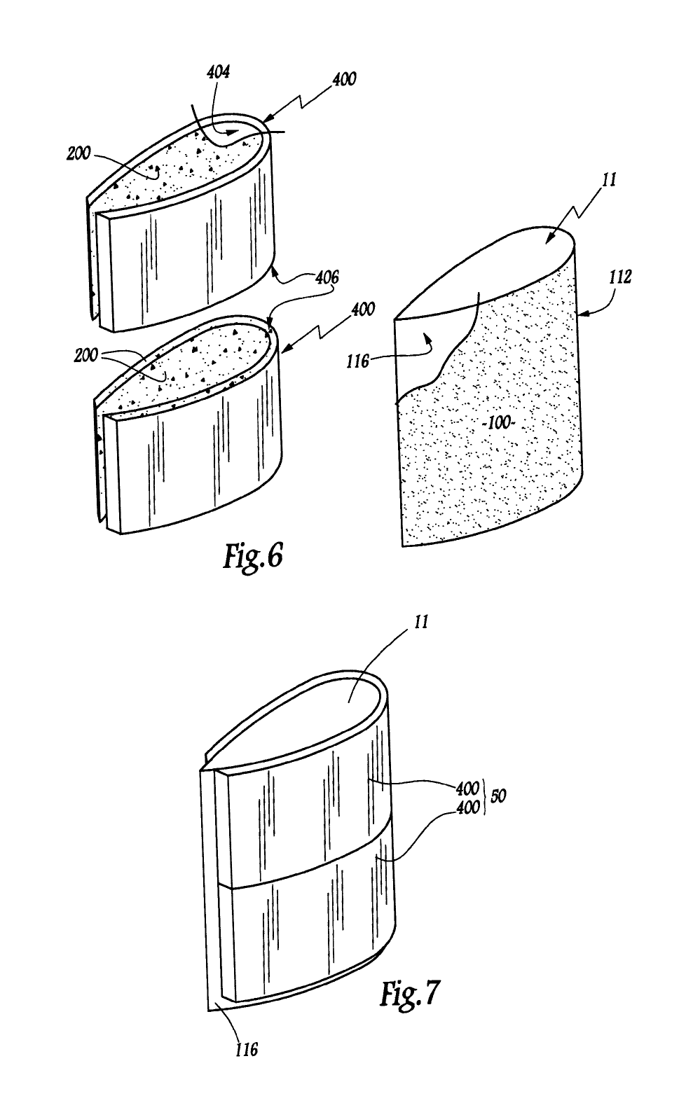

FIG. 6 is a perspective view of a wicket gate of the installation of FIG. 1 during a first step of its method of manufacture and,

FIG. 7 is a perspective view analogous to FIG. 6 during a subsequent step of its method of manufacture.

The installation 1 shown in FIG. 1 comprises a Francis turbine 2 of which the wheel 3 is supplied using a tank 4 wherein opens a forced line 5. The turbine 2 further comprises a shaft 6 whereon is mounted the wheel 3 and which rotates with it around a vertical axis X₆, with this axis also being a longitudinal axis of the shaft 6. The shaft 6 is integral in rotation with another shaft 7 forming a member for driving an alternator 8. As such, the installation 1 converts the hydraulic energy into electrical energy. Alternatively, the alternator 8 can be replaced with a mechanical device, in which case the installation 1 converts the hydraulic energy into mechanical energy.

Between the tank 4 and the wheel 3 is arranged a series of stay vane wicket gates 9 and wicket gates 11 of which the function is to guide a flow E coming from the line 5 and from the tank 4 and intended to pass through the wheel 3, in the direction of a suction line 12.

The wheel 3 comprises vanes 31 which extend between a hub 32 and a crown 33. Each vane 31 extends between a leading edge 312 and a trailing edge 314 with two lateral surfaces which extend between the leading edge and the trailing edge. One of these surfaces can be seen, with the reference 316, in FIGS. 2 to 5.

The surface 316 and the opposite surface, which extends from the other side of the vane 31 in relation to that shown in FIGS. 2 to 5, are swept by the flow E when the installation 1 is operating. In practice, the flow E flows along surfaces 316 and equivalents with a speed greater than or equal to 20 metres per second (m/s). In order to prevent this flow from prematurely wearing the surface 316 and the surface opposite the vane 31, a protective layer of coating 50 against erosion is affixed onto these surfaces, 316 and analogous.

To do this, when the wheel 1 is carried out, the vanes 31 are sandblasted. A first coat 100 of material referred to as “primer” is then applied on the surface 316, this coat 100 of primer having for effect to facilitate the fixing, with regards to the vane 31, of another coat affixed subsequently onto the coat 100. In FIG. 2, the coat 100 is shown during application, which shows a portion of the surface 316 in the vicinity of the leading edge 312 and of the hub 32.

The primer used on this occasion is a mixture of isocyanate and polyol.

The coat 100 of primer is applied with a spray gun with a thickness between 20 and 100 μm, more preferably of a magnitude of 50 μm.

As the geometry of the wheel 3 is known as soon as it is created, the manufacturing of sheets of polymerised synthetic material is scheduled in advance, in a sufficient number and with unit surfaces that are sufficient to cover all of the lateral 316 and equivalent surfaces of the vanes 31. Four of these sheets are shown in FIG. 4 with the reference 300 coated with 200, before they are laid on the surface 316 of the vane 31, coated with the coat 100.

Each sheet 300 is prefabricated by polymerising a prepolymer base, which can be of the isocyanate type partially copolymerised with at least one polyol or/and one amine, with a hardener of the isocyanate type. Advantageously, one or several fluidifying agents and/or dispersant are incorporated into the prepolymer base, as well as one or several fillers, for example a ceramic tiller, of the titanium nitride, nano-powder type or other. One or several catalysts can also be used during the manufacturing of the sheets 300.

Once polymerised, the material comprising the sheets 300 is of the polyurethane type.

The sheets 300 can be prepared several weeks before they are laid on the lateral surfaces 316 of the vanes 31. In practice, the sheets 300 are carried out with a thickness e₃₀₀ between 0.5 and 3 mm. Entirely satisfactory results are anticipated with sheets of which the thickness is between 1 and 2 mm.

The materials that comprise sheets 300, i.e. the base and the hardener, are mixed according to a weight ratio of about 2/3 for the base and 1/3 for the hardener. They are then poured into a mould arranged in a flat state. A polymerisation reaction is then obtained which results in the creation of sheets 300. These sheets are then left to rest by storing them for several weeks, more preferably for at least two months, in order to obtain a full set in the thickness of the sheets and the end of the polymerisation reaction.

As such, the manufacture of sheets 300 is anticipated in relation to the manufacture of the metal parts of the wheel 3.

The step of preparation and the step of storage of the sheets 300 take place in a flat state, in a protected environment, in such a way that the face 302 of each sheet 300 which is intended to be oriented towards the flow E once the sheet 300 mounted on the wheel 3 can have a well-controlled surface finish, in particular of the smooth or “mirror” type.

After the step of preparing and of storing the sheets 300, each of these sheets can be manipulated by hand, without the risk of becoming polluted or having its mechanical properties and its surface finish damaged by surrounding dust.

At the end of their preparation and after fully setting, the sheets 300 have a Shore hardness of 72, with an elastic elongation capability of about 400%. Their tensile strength, according to standard NF T 46-002, is 28 megapascals (MPa), while their resistance to tearing, according to standard NF T 46-007, is 35 newtons (N).

As such, for the manufacturing of the wheel 3, there is a sufficient number of sheets 300, with adapted dimensions and mechanical characteristics. For example, each sheet 300 can have a length of a magnitude of 2 metres (m) and a width of a magnitude of 500 mm.

When the sheets 300 intended to cover the surface 316 are identified, the face 304 of each sheet 300 intended to be turned towards the surface 316 is coated using a spray gun with a coat 200 of adhesive material. This adhesive material is advantageously a polyurethane. This can however be another material such as polyester, cyanoacrylate or a material with a polyurethane, polyester or cyanoacrylate base. Here, the term “cyanoacrylate” is used as it is normally accepted and designates methyl 2-cyanoacrylate. The coat 200 of adhesive is applied with a thickness e₂₀₀ between 20 and 150 μm, more preferably between 50 and 70 μm. In FIG. 4, the thickness e₂₀₀ is exaggerated in order to facilitate the marking of the coat of adhesive 200. In practice, the coat of adhesive 200 is also applied on some or all of the edges or sections 306 of the sheets 300.

Once the step of applying the coat of adhesive 200 has been carried out, there is a waiting period of approximately one-hour in order to allow the adhesive and the primer to mature, before laying each sheet 300 coated with the coat of adhesive 200 on the surface 316 or equivalent of a vane 31 coated with the coat 100. The face 304 of each coat is then pushed in the direction of the surface 316, which brings into contact the coats 100 and 200. According to the geometry of the surfaces 316, one or several sheets 300 can be cut in order to follow the connecting edge 322 between the vane 31 and the hub 32 or the connecting edge 332 between the vane 31 and the crown 33.

The coat 200 of adhesive is applied with a thickness e₂₀₀ between 20 and 150 μm, more preferably between 50 and 70 μm.

The choice of materials comprising the coat of primer 100 and the coat of adhesive 200 ensures that the coat 200 firmly adheres to the coat 100, which guarantees of each sheet 300 is maintained in position on the vane 31.

In FIG. 3, the arrows F₁ show the movement of the laying of the sheets 300 on the surface 316, while the dotted lines L₃₀₀ delimit the position provided for the various sheets 300. The use of these dotted lines is optional. They facilitate the installation of the sheets 300 by serving as a guideline for the operator.

At the end of the step of manufacturing of the portion of the wheel 3 corresponding to the vane 31 shown in FIGS. 2 to 5, four sheets 300 are in place on the surface 316, arranged edge to edge, as shown in FIG. 5. This is possible since the sheets 300 are manufactured in the same way, with a well-controlled thickness, in such a way that their respective surfaces turned towards the flow E can be flush with each other. The action of gluing the edges 306 of the sheets 300 combined with the very high elasticity of the sheets favours the continuity of their respective surfaces 302, without any lip.

The sheets 300 constituent ensemble the protective layer of coating 50 of the surface 316 against erosion. Their geometry is adapted to that of the surface 316 by taping or any other suitable technique.

In light of the waiting period for the maturing of the adhesive and of the primer mentioned hereinabove, before the laying of the sheets 300, the viscosity of the coats 100 and 200 is sufficient to prevent a sliding of the sheets 300 with regards to the vane 31 once the sheets 300 provided with the coat of adhesive 200 are laid on the coat 100.

Once the sheets 300 are in place, as shown in FIG. 5, it is sufficient to wait between 48 and 96 hours (h) before putting the wheel 3 into service.

As shown in FIGS. 6 and 7, a wicket gate 11 can also be provided with a protective layer of coating 50 against the erosion formed of sheets 400 of polymerised synthetic material.

The outside surface 116 of the wicket gate 11 is coated beforehand with a coat of primer 100, before the sheets 400 coated beforehand with a coat of adhesive 200, on a face 404 intended to be turned towards the wicket gate, are affixed onto the coat 100, after the maturing of these coats. Note in FIG. 7 that the sheets 400 extend over the surface 102 of the wicket gate 10 in such a way as to cover its leading edge 112. Also note in this figure that the sheets 400 do not entirely cover the surface 116. It is however possible to provide a complete covering of this surface with sheets 400.

In FIG. 6, the coat 200 is shown as it is being applied, which shows the face 404 of one of the sheets 400. As previously, the coat of adhesive 200 can also be applied on certain edges 406 of the sheets 400, in particular the upper edge of the lower sheet 400 and/or the lower edge of the upper sheet 400. The sheets 400 together constitute the protective layer of coating 50 for the surface 116 against erosion.

The sheets 400 are manufactured in the same way as the sheets 300 and substantially have the same properties.

In light of their thickness and the material they are comprised of, the sheets 300 and 400 are flexible enough to adapt to the warped/uneven geometry of the surfaces 116 and 316 which are warped/uneven, in particular which cannot be developed.

Other portions of the installation 1 can be protected by a protective layer of coating in sheets implemented in accordance with the invention. In particular, the surfaces of the hub 32 and of the crown 33 which are oriented towards the vanes 31 can be provided with sheets analogous to the sheets 300. The stay vane wicket gates 9 can also be provided with sheets of the type of sheets 400 shown in FIG. 7.

The invention is particularly advantageous in the case of rehabilitating an existing installation 1. Indeed, insofar as the geometry of the wheel 3, of the stay vane wicket gates 9 or of the wicket gates 10 is known before intervention on site, sheets 300, 400 and equivalents can be prepared in an adapted number, in the two months preceding the stoppage of the installation. During the stoppage of the installation, the entire wheel 3 can be sandblasted and the coat of primer 100 and coat of adhesive 200 can be applied before a fast laying of the sheets 300 and/or 400 on the surfaces to be protected against erosion. Insofar as the intervention on the wheel 3 is relatively fast, there is no risk of oxidation of the metal and the sandblasting or the grinding can take place over a large surface. As the sheets 300 or 400 have been subjected to a step of storage for several weeks, they can be qualified as “inert”, in that the polymerisation reaction is completed, in such a way that they do not risk being damaged by dust when they are laid on the wheel 3 or the wicket gates 11 and during the drying of the coat of adhesive 200 before the water flow of the installation 1 is turned on.

The technical characteristics of the embodiments and alternatives mentioned hereinabove can be combined together.

Although highly advantageous, the use of a coat of primer 100 is not mandatory and it can be considered to apply the coat of adhesive 200 directly on the surface 116, 316 or equivalent of a component 3, 11 or other.

In the figures, the sheets 300 and 400 are shown with straight edges. Alternatively, these edges can be bevelled. In this case, the edge of one sheet can cover the edge of another adjacent sheet. The coat of adhesive then extends between these two edges.

The invention applies to any component of a hydraulic machine, whether this component is mobile or fixed. The invention can be used in a turbine of any known type, such as Francis, Kaplan, bulb, etc., in a pump or in a turbine-pump. When the invention is used in a pump or a turbine pump, the installation converts the mechanical or electrical energy into hydraulic energy.

1. A method of protection against erosion of a component of a hydraulic machine of which at least one warped/uneven surface is covered by a protective layer of coating, wherein the method comprises:
a) preparing in a flat state several sheets of polymerised synthetic material,
b) applying a coat of adhesive at least on one face of each sheet,
c) laying the sheets by pushing them against the warped/uneven surface of the component that is to be covered and by constituting the layer of coating using sheets, in such a way that the layer of coating is formed by the sheets prepared in step a).

2. The method according to claim 1, wherein during the step a) the sheet is carried out using a prepolymer base and a hardener.

3. The method according to claim 1, wherein during the step a), the sheet is carried out with a thickness between 0.5 and 3 mm.

4. The method according to claim 1, wherein the method further comprises an intermediary step d) between the steps a) and b), of storing the sheet for finalisation of the polymerisation.

5. The method according to claim 4, wherein the step of storing takes place for several weeks.

6. The method according to claim 1, wherein, during the step c), the sheets are laid edge to edge.

7. The method according to claim 1, wherein the method further comprises a step e), prior to the step c), of applying a coat of primer on the surface of the component that is to be covered with the protective layer of coating against erosion and wherein during the step c) the sheet is laid by placing into contact the coat of adhesive and the coat of primer.

8. The method according to claim 7, wherein, during the step e), the primer is applied with a thickness between 20 and 100 μm.

9. The method according to claim 7, wherein the method further comprises a step f) after the steps b) and e) wherein there is a waiting period for the adhesive and the primer to mature, before the laying of the sheets in the step c).

10. The method according to claim 1, wherein, during the step b), the adhesive is applied with a thickness between 20 and 150 μm.

11. The method according to claim 1, wherein the adhesive applied during the step b) is of the polyurethane type or with a polyurethane base, of the polyester type or with a polyester base, or of the cyanoacrylate type or with a cyanoacrylate base.

12. A component of a hydraulic machine wherein some at least of the warped/uneven surfaces of this component intended to be wet by a forced flow of water passing through the machine, are covered with a protective layer of coating formed of several sheets prepared via polymerisation in a flat state before they are laid on these surfaces.

13. The component according to claim 12, wherein the sheets have a Shore hardness of 72, with an elastic elongation capability of about 400%.

14. The component according to claim 12, wherein the sheets have a tensile strength, according to standard NF T 46-002, of 28 megapascals and a resistance to tearing, according to standard NF T 46-007, of 35 newtons.

15. An installation for converting hydraulic energy into electrical or mechanical energy, or reciprocally, this installation comprising a hydraulic machine, a line for supplying water to the hydraulic machine and at least one component of which at least one surface is swept by a forced flow of water passing through the installation, wherein the component is according to claim 12.

16. The method according to claim 2, wherein the prepolymer base comprises an isocyanate type partially copolymerised with at least one polyol and/or one amine.

17. The method according to claim 16, wherein the harder is of the isocyanate type.

18. The method according to claim 3, wherein during the step a), the sheet is carried out with a thickness between 1 and 2 mm.

19. The method according to claim 5, wherein the step of storing takes place for at least two months.

20. The method according to claim 8, wherein, during the step e), the primer is applied with a thickness of a magnitude of 50 μm.

21. The method according to claim 10, wherein, during the step b), the adhesive is applied with a thickness between 50 and 70 μm.
